(19) United States
(12) Patent Application Publication
(10) Pub. No.: US 2012/0287373 A1
(43) Pub. Date: Nov. 15, 2012

(54) LIGHT SOURCE DEVICE FOR BACKLIGHT MODULE AND LIQUID CRYSTAL DISPLAY AND METHOD FOR MANUFACTURING THE SAME

(75) Inventors: Wen Chin Tsai, Hukou Township (TW); Wang Sheng Lin, Hukou Township (TW)

(73) Assignee: JOCHU TECHNOLOGY CO., LTD.

(21) Appl. No.: 13/281,384

(22) Filed: Oct. 25, 2011

Related U.S. Application Data
(60) Provisional application No. 61/484,688, filed on May 11, 2011.

(51) Int. Cl. G02F 1/1335; F21V 29/00; B29C 65/00; B32B 37/14; B29C 47/00; F21S 4/00; G09F 13/04

(52) U.S. Cl. 349/62; 362/249.02; 362/97.1; 156/60; 156/244.11

(57) ABSTRACT

A light source device for a backlight module, including a heat sink; and a light bar including a plurality of light emitting diodes (LEDs) and a substrate on which the LEDs are electrically provided. The substrate is bonded to the heat sink via a bonding portion through which heat generated by LEDs is transferred to the heat sink. Also, a method for manufacturing a light source device, including providing a light bar having a plurality of LEDs thereon; providing a heat sink; and bonding a substrate of the light bar to an upper surface of the heat sink such that they are integrated firmly into one piece. In this way, the heat dissipation effect can be improved by means of preventing the substrate of the light bar from deforming and further separating from the heat sink.

### CROSS-REFERENCE TO RELATED APPLICATIONS

This application claims priority benefit of U.S. Provisional Patent Application No. 61/484,688, filed on May, 11, 2011 and entitled “ ” which is hereby incorporated herein by reference.

### BACKGROUND OF THE INVENTION

1. Field of the Invention

The invention relates to a light source device for backlight module and liquid crystal display and a method for manufacturing the same, more particularly, relates to a light source device that uses light emitting diodes as the light source, method for manufacturing the light source device, and a backlight module and liquid crystal display having the light source device.

2. Description of the Prior Art

Light emitting diodes (LEDs) have been widely used in the backlight module of the liquid crystal display owing to the merits of low power consumption, wide color gamut, adjustable chromaticity, and eco-friendly interest. The color rendering property of the liquid crystal display is enhanced through using LEDs as the backlight source.

The backlight module may be classified into two types, i.e., the bottom- and edge-types, according to the arrangement of LEDs. For the edge-type one, high-power LEDs have to be employed therein for producing sufficient luminance due to limit of the number of LEDs. An edge type backlight module generally includes a light guide plate, an optical film, a heat sink, and a LED light bar. In a conventional backlight module, the LED light bar is attached to the heat sink by the securing members like screws or bolts. In this way, the heat energy generated during the operation of the LED light bar may be transferred by conduction to the heat sink, decreasing the temperature of the LED light bar.

However, the LED light bar already attached to the heat sink expands and bends because of the heat generated during the LED operation, a gap is thus formed between the LED light bar and the heat sink. Except at the part where the LED light bar contacts with the heat sink, heat can only be conveyed by air from the former to the latter. Therefore, the temperature of the LED light bar cannot be reduced effectively. The optical attenuation of LEDs caused by the over temperature will lead to diminished luminous efficiency and service life.

### SUMMARY OF THE INVENTION

In view of the forgoing problems, the invention discloses a light source device including a heat sink and a light bar. The light bar comprises a plurality of LEDs and a substrate on which the plurality of LEDs are provided. The substrate is bonded to an upper surface of the heat sink via a side surface thereof and a “bonding portion” is formed between the substrate and the heat sink. The heat generated by the plurality of LEDs can be transferred by conduction to the heat sink through the bonding portion.

The invention also discloses a backlight module comprising at least a light source device and a light guide plate. The light source device comprises a heat sink and a light bar, and the light bar comprises a substrate and a plurality of LEDs. The LEDs are provided on the substrate, and the substrate is bonded to an upper surface of the heat sink via a side surface therefore forming a bonding portion between the heat sink. The heat generated by the LEDs is conducted to the heat sink through the bonding portion. The light guide plate has a light incident surface that substantially faces the LEDs.

The invention further discloses a liquid crystal display comprising at least a backlight module and a liquid crystal panel display module. The backlight module comprises a light source device and a light guide plate, the light source device comprises a heat sink and a light bar, and the light bar comprises a substrate and a plurality of LEDs. The LEDs are provided on the substrate, and the substrate is bonded to an upper surface of the heat sink via a side surface therefore forming a bonding portion between the heat sink. The heat generated by the plurality of LEDs is conducted to the heat sink through the bonding portion. The light guide plate has a light incident surface that substantially faces the plurality of LEDs, and the liquid crystal panel display module is provided facing a light emitting surface of the light guide plate.

The invention further discloses a method for manufacturing a light source device comprising providing a light bar having a plurality of LEDs thereon; providing a heat sink; and bonding a substrate of the light bar to the heat sink such that a bonding portion is formed between the substrate and the heat sink.

In the invention, the substrate of the light bar is integrated tightly with an upper surface of the heat sink by welding or sealing, preventing the substrate of the light bar from deforming and further separation from the heat sink.

Besides, since the substrate of the light bar is bonded to the surface of the heat sink by welding or sealing, where the substrate and the heat sink connect (i.e., the bonding portion) is formed by direct fusion of the respective materials of both. The bonding portion may also be formed by using a fusion agent having a different composition from both. Consequently, the bonding portion as a heat transfer medium of the invention has the composition formed by fusing each other the materials of the substrate and the heat sink or by additionally fusing a different material into both.

The light source device of the invention has high structural strength and a superior effect of heat transfer. It is possible to use high-power LEDs therein because of good heat dissipation. As a result, the number of LEDs set in the light source device will be decreased favorably. Also, the heat sink can be made at low cost. That is, the light source device of the invention can furnish sufficient luminance with a less number of LEDs, thus reducing the cost of the light bar of the light source device.

The characteristics, realization and functions of the invention are disclosed in the following description with reference to the preferred embodiments and the accompanying drawings.

### BRIEF DESCRIPTION OF THE DRAWINGS

FIG. 1 is a schematic side view of a backlight source module of the invention;

FIG. 2A is a schematic diagram showing the process of manufacturing a light bar of the invention;

FIG. 2B is an enlarged view of part of FIG. 2A.

FIG. 3 is a flow chart showing the process of manufacturing the light source device of the invention;

FIG. 4 is a schematic diagram showing where the temperature measurement in the light source device was taken;

FIG. 5 is a diagram showing the compared result of the temperature measurement;

FIG. 6 is an exploded view of the light source device of the invention.

FIG. 7 is a flow chart showing the process of manufacturing the light source device of the invention;

FIG. 8 is a schematic side view of the light source device of the invention;

FIG. 9 is another schematic side view of the light source device of the invention;

FIG. 10 is still another schematic side view of the light source device of the invention; and

FIG. 11 is a schematic side view of the liquid crystal display of the invention.

### DETAILED DESCRIPTION OF THE INVENTION

In the following embodiments, for the purpose of convenience, the edge type backlight modules are employed as illustrations for the light source device. However, a person of ordinary skill in the art will appreciate that the light source device of the invention can be applied to bottom- and edge-types backlight modules. It is intended to be an illustration rather than a limitation.

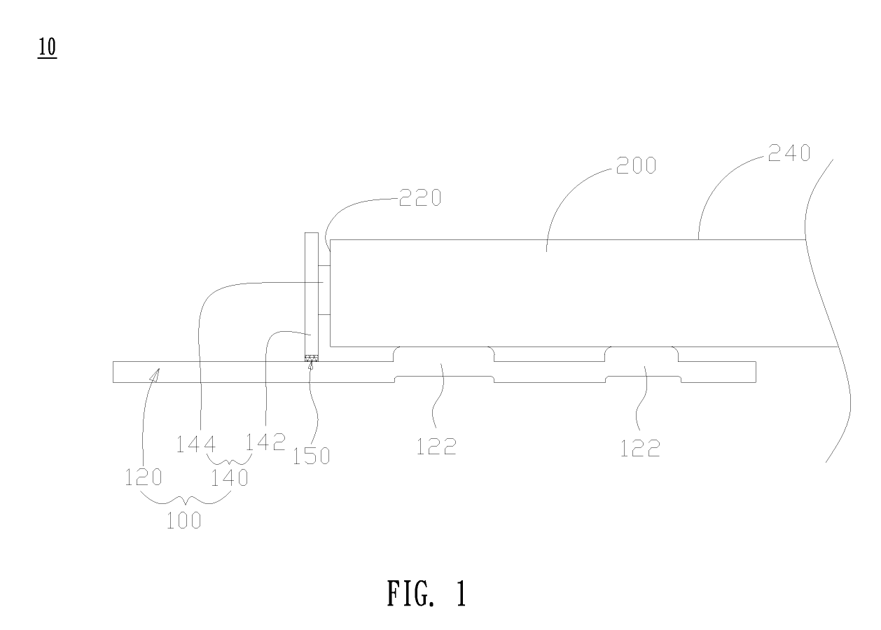

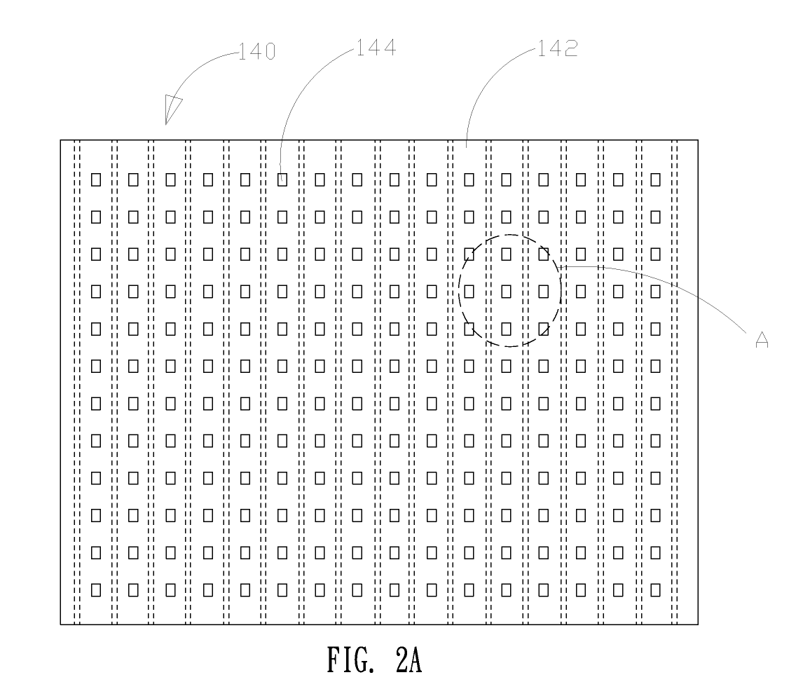

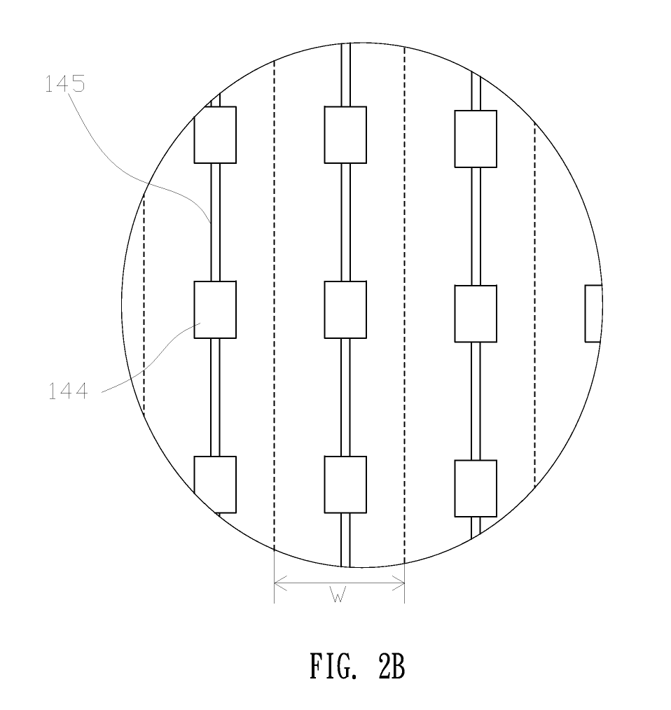

FIG. 1 is a schematic side view of a backlight source module 10 of the invention including at least a light source device 100 and a light guide plate 200. The light source device 100 includes a heat sink 120 and a light bar 140, and the light bar 140 is composed of a substrate 142 and a plurality of light emitting diodes (afterwards, LEDs for short) 144, as shown in FIG. 2A. Conventionally, when manufacturing the light bar 140, an array of LEDs 144 are arranged on the substrate 142, which is then cut into strips, thus the plurality of light bars 140 are formed. The details will not be described here for avoiding unnecessary confusion with the invention. For the purpose of facilitating the heat dissipation, substance with good thermal conductivity, such as aluminum or copper, may be used as the material of the heat sink 120.

A support 122 configured to hold the light guide plate 200 is formed, for example, by extending the heat sink 120 such that the light guide plate 200 is disposed on the support 122 of the heat sink 120, while a part of the light guide plate 200 is located above the heat sink 120. A light incident surface 220 of the light guide plate 200 substantially faces the LEDs 144 of the light bar 140. After the LEDs 144 are powered, light generated by the LEDs 144 enters into the light guide plate 200 from the light incident surface 220. Through the refraction within the light guide plate 200, the light is transmitted to the surroundings.

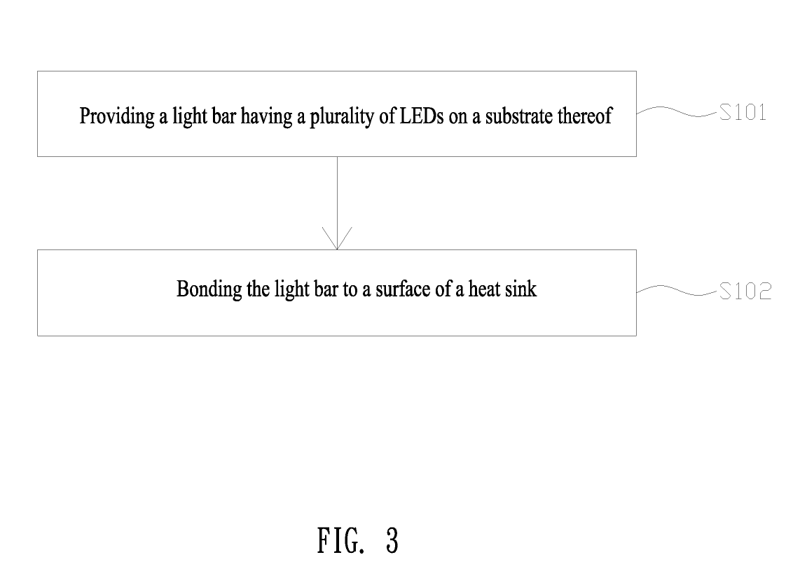

Referring to FIGS. 1 and 3, for manufacturing the light source device 100, providing first the light bar 140 including the LEDs 144 thereon and the heat sink 120 (S101). Next, a surface of the substrate 142 of the light bar 140 is bonded to an upper surface of the heat sink 120 (S102) such that a bonding portion 150 is formed between the substrate 142 and the heat sink 120. In this embodiment, the substrate 142 of the light bar 140 “stands” firmly on the heat sink 120 (i.e., the substrate 142 is placed in a substantially vertical direction with respect to the heat sink 120) via the bonding portion 150. The LEDs 144 on the substrate 142 look like being “hung” over the heat sink 120 from a vertical view, and are located between the substrate 142 of the light bar 140 and the support 122 of the heat sink 120 from a horizontal view. Besides, when the light guide plate 200 is disposed on the support 122 of the heat sink 120, the light incident surface 220 of the light guide plate 200 substantially faces the LEDs 144 of the light bar 140, so as to provide the liquid crystal display with an edge-type backlight module. It will be appreciated that the bonding surface of the substrate 142 to the heat sink 120 may be selected based on the design of the backlight module 10. For example, for a bottom-type backlight module, the bonding surface of the substrate 142 will be the surface opposite to the LEDs 144.

It is to be noted that the substrate 142 of the light bar 140 is bonded to the heat sink 120 by welding or sealing, such that the bonding portion 150 there between is formed by direct fusion of the materials of the substrate 142 and the heat sink 120, or by using some welding substance having different composition from the both as a fusion agent. In this way, when the light source device 100 is in operation, the heat can be conducted to the heat sink 120 by using the bonding portion 150 as a heat transfer medium. If the welding substance is desired, the material thereof is preferably selected from the group with higher thermal conductivity.

Referring to FIGS. 2A and 2B, as described above, since the substrate 142 of the light bar 140 is bonded to the heat sink 120 by welding or sealing in the light source device 100 of the invention, it's not necessary for the substrate 142 to be provided with threaded holes for fastening the securing members like screws or bolts. On the other hand, the circuits 145 may electrically connect each of the LEDs 144 in a shorter distance without interference of the threaded holes. Therefore, the size of the substrate 142 of the light bar 140 can be smaller owing to the smaller area occupied by the circuits, which is beneficial in decreasing the manufacturing cost and meeting the need for miniaturization. However, the size of the substrate 142 of the light bar 140 may be determined as desired, so it is appreciated to be illustrative rather than restrictive.

Next, it will be proved that the light source device of the invention, when compared with the conventional one, can provide a better effect of heat dissipation. The light source device where the substrate of the light bar and the heat sink are combined respectively by welding and screws is denoted as Sample A, while the conventional device where both elements are combined by screws is denoted as Sample B. The same light bar and the same heat sink with the specifications indicated as follows are used in the above two light source devices for comparison.

Size of Substrate: 420 mm (length)×8 mm (width)×1.5 mm (thickness)
LED: power of 0.4 W per die (44 LEDs in total)
Size of Heat Sink: 420 mm (length)×35 mm (width)×2 mm (thickness)
In Sample A: Contact (Welded) length of the substrate with the heat sink being 420 mm.
In Sample B: The substrate being threaded into the heat sink every 8 mm with one screw; the diameter of the threaded hole being 25 mm; and contact length of the substrate with the heat sink being 420 mm.

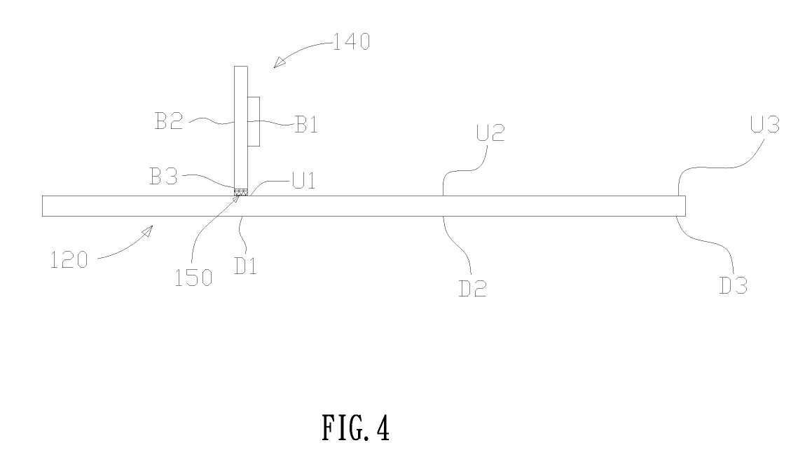

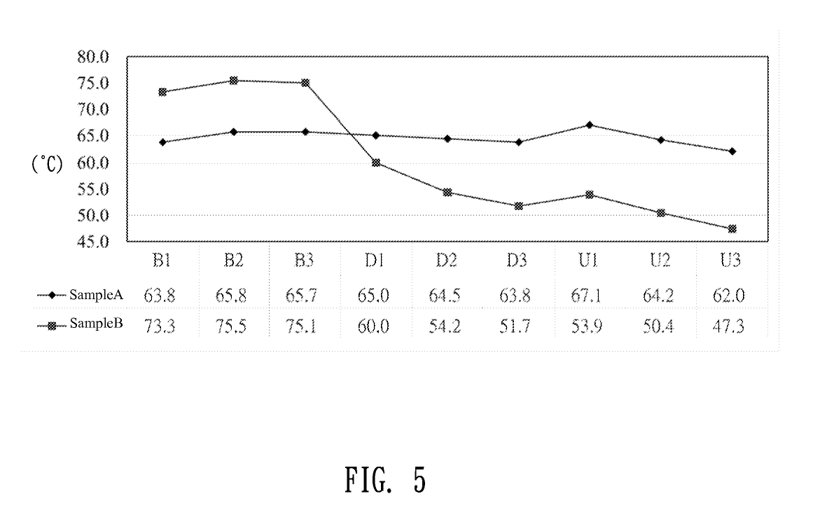

Sample A and Sample B are respectively placed within an enclosed chamber. Temperature measurements are taken 2 hours after being powered. FIG. 4 is a schematic diagram showing where (the measuring points) the temperature measurement in the light source device was taken, Samples A and B; FIG. 5 is a diagram showing the compared result of the measurements with respect to the measuring points. For the substrate, the measuring points are B1, B2, and B3; for the heat sink, the measuring points are D1, D2, and D3 at the bottom and U1, U2, and U3 on the surface. The result shows, for the temperature of the substrate at each measuring point, Sample A is lower than Sample B; for the temperature of the heat sink at each measuring point, Sample A is higher than Sample B. It means that the heat transfer efficiency between the substrate and the heat sink is better in Sample A than in Sample B. Thus, the temperatures of the substrate and the operating temperature of the LEDs are reduced more effectively in Sample A, since the substrate of Sample A enables a more efficient transfer of the heat generated by the LEDs to the heat sink.

In more detail, the fact that the temperature of the heat sink is higher indicates that the heat can be transferred more effectively from the light bar to the heat sink. In Sample A, the bonding portion which is formed by fusing the material of the substrate with the material of the heat sink serves as an efficient heat transfer medium, while in Sample B, screws mainly play the role of the bonding portion. Further, in Sample A, the temperatures at some measuring points on the heat sink are observed even higher than on the substrate. The inventor tried to evaluate the heat transfer between the substrate and the heat sink with a ratio of the average temperature of the substrate to the average temperature of the heat sink. If the ratio is around 1; that is, the average temperature of the substrate is approximately the average temperature of the heat sink, it is contemplated that the heat of the substrate can be transferred to the heat sink during a short period of time. On the contrary, if the ratio is less than 1, it is contemplated that the heat transfer between the substrate and the heat sink is excellent since most of the heat of the substrate has been transferred to the heat sink.

The ratio for Sample A is about 0.85-1.1 in one embodiment, 0.9-1.07 in another embodiment, 0.95-1.05 in still another embodiment.

Referring to FIGS. 4 and 5, the ratio of the average temperature of the substrate (about 65.1° C.) to the maximum temperature of the heat sink (about 67.1° C.) is approximately 0.97, and the ratio of the average temperature of the substrate to the minimum temperature of the heat sink (about 62° C.) is approximately 1.05. So in this embodiment, for Sample A, the ratio of the average temperature of the substrate to the average temperature of the heat sink is approximately 0.97-1.05, and the ratio of the average temperature of the substrate to the average temperature of the heat sink is about 1.01. The analysis demonstrates that the bonding portion of Sample A is capable of transferring most of the heat from the substrate to the heat sink, thus facilitating the heat dissipation of LEDs via reducing the temperature of the substrate.

However, in Sample B, the ratio of the average temperature of the substrate (about 74.63° C.) to the maximum temperature of the heat sink (about 60° C.) is approximately 1.24, and the ratio of the average temperature of the substrate to the minimum temperature of the heat sink (about 47.3° C.) is approximately 1.57. So in this embodiment, for Sample B, the ratio of the average temperature of the substrate to the average temperature of the heat sink is approximately 1.24-1.57, and the ratio of the average temperature of the substrate to the average temperature of the heat sink is about 1.41. The analysis demonstrates that the heat generated by the LEDs cannot be transferred effectively from the substrate to the heat sink in Sample B and then accumulates on the substrate, resulting in a situation that the temperature of the substrate is higher than that of the heat sink throughout.

From the above comparison, it is evident that Sample A obviously has a better heat transfer effect that can effectively decrease the temperature of the light bar and thus is capable of preventing the LEDs on the light bar from luminance decay. As a whole, the luminous efficiency of LED is well maintained and the service life thereof is prolonged for Sample A.

It is to be noted that the heat sink 120 may be formed by extrusion molding, but the invention is not limit thereto. For example, an aluminum-extruded finned radiator with enhanced heat dissipation effect and structural strength may be used. However, the heat sink 120 of the light source device 100 of the invention, even formed by a cheaper way like stamping, may still have a better heat transfer effect which can significantly reduce the temperature of the light bar 140.

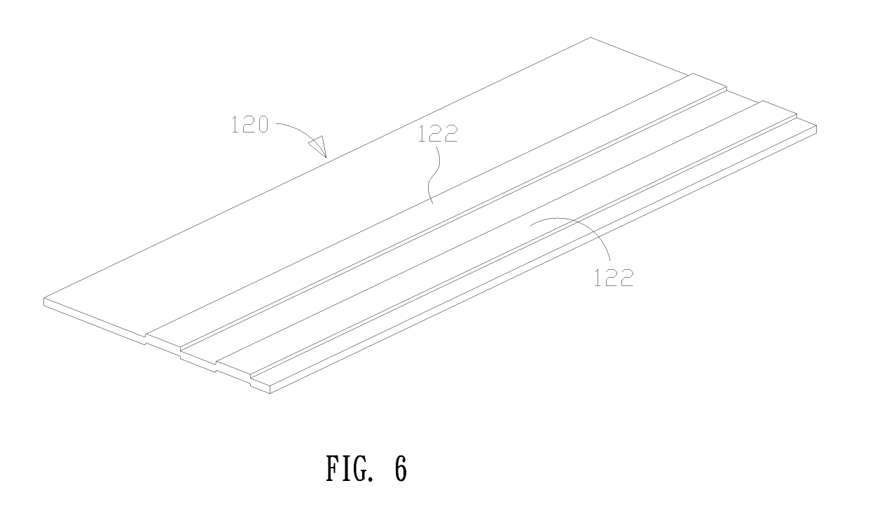

As shown in FIG. 6, the heat sink 120 and the aforementioned support 122 both may be formed by stamping into one piece integrally to improve the structural strength thereof.

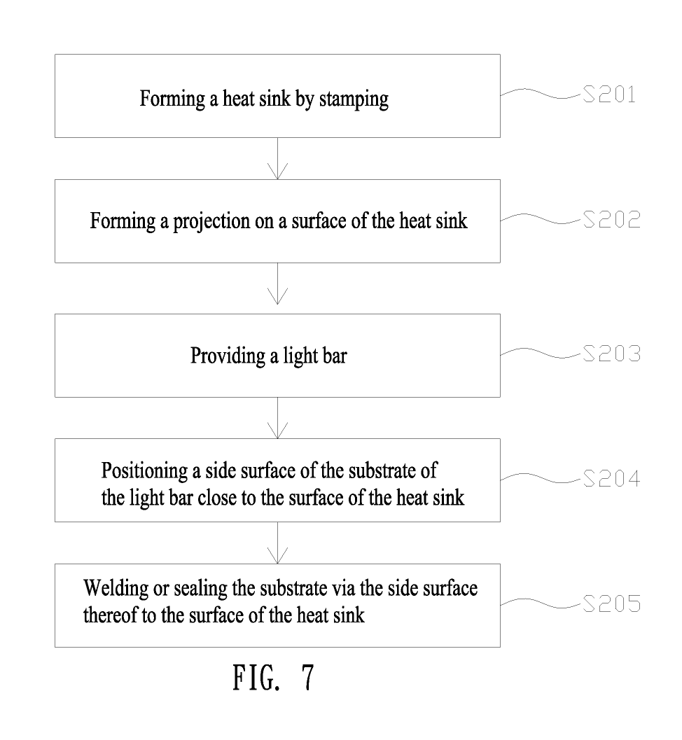

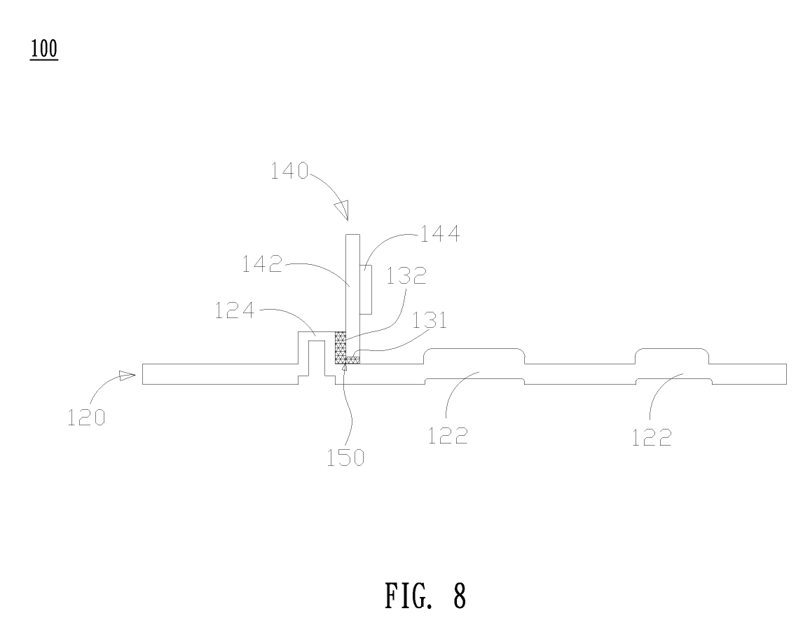

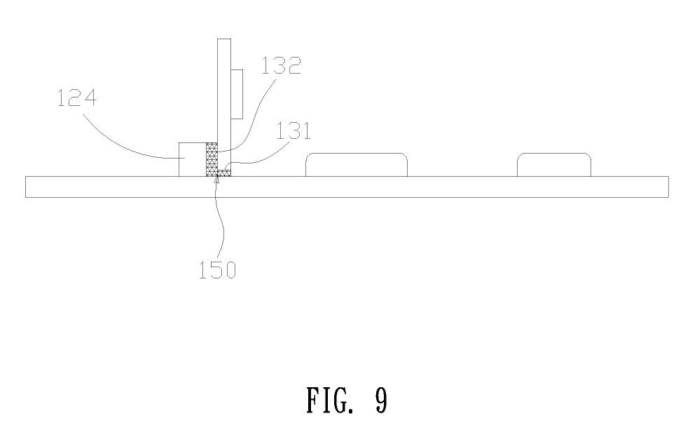

FIGS. 7-9 further provide a method for manufacturing a light source device 100, comprising: forming a heat sink 120 by stamping (S201); forming a projection 124 on a surface of the heat sink 120 (S202); providing a light bar 140 having a plurality of LEDs 144 thereon and a substrate 142 on which the plurality of LEDs 144 are disposed (S203); positioning a side surface of the substrate 142 of the light bar 140 parallel to the upper surface of the heat sink 120 (S204); and welding or sealing the substrate 142 via the side surface thereof to the upper surface of the heat sink 120 with a bonding portion 150 formed there between (S205). Thus is completed the manufacture of the light source device 100. Particularly, in this embodiment, the heat sink 120 is composed of material with good thermal conductivity like aluminum or copper. At S202, the projection 124 may be formed by (but is not limited to) stamping on the surface of the substrate 142 for being integrated with the substrate 142 (as shown in FIG. 8), or the projection 124 may be formed by welding or sealing on the surface of the substrate 142 (as shown in FIG. 9). At S204, the substrate 142 is preferred to be positioned with one surface facing the upper surface of the heat sink 120 and another surface facing the sidewall of the projection 124.

At S205, the bonding surface of the substrate 142 may be selected as desired. For example, the substrate 142 may be bonded by welding or sealing to the heat sink 120 via a first bonding surface 131 of the substrate 142 that faces the upper surface of the heat sink 120. So, the bonding portion 150 is formed by direct fusion of the materials of the both. Alternatively, the bonding portion 150 may be formed by using a fusion agent having different material from the both. Still alternatively, the substrate 142 may be bonded by welding or sealing to the heat sink 120 via a second bonding surface 132 of the substrate 142 that faces the sidewall of the projection 124. The first bonding surface 131 and the second bonding surface 132 may be bonded together by welding or sealing, which will increase not only the contact area of the substrate 142 of the light bar 140 with the surface of the heat sink 120 but the structural strength of the combination.

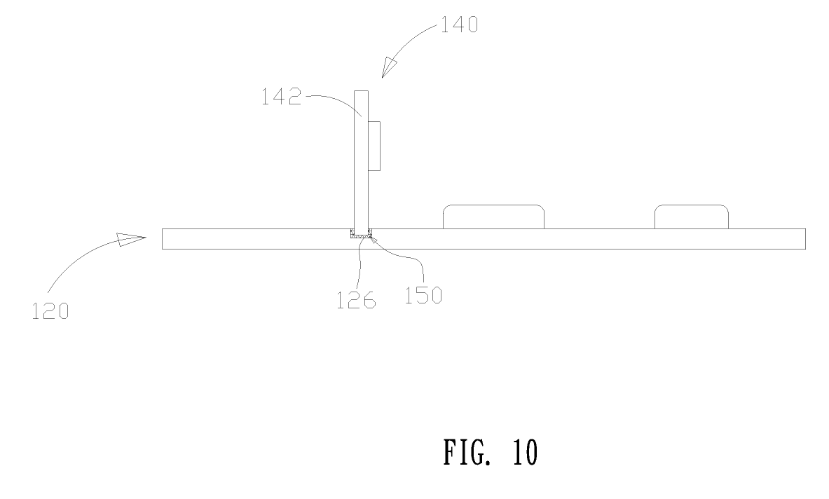

Besides, by referring to FIG. 10, in the above method for manufacturing the light source device 100, a recess 126 may be formed integrally in the upper surface of the heat sink 120 by stamping for example. Then, the substrate 142 of the light bar 140 is bonded to the heat sink 120 via the recess 126. Similarly, the recess 126 is beneficial to increase not only the contact area of the substrate 142 of the light bar 140 with the surface of the heat sink 120 but the structural strength of the combination.

As mentioned above, for the light source device 100 of the invention, the heat sink 120 may be formed by stamping or extrusion molding, and the projection 124 or recess 126 can not only increase the contact area of the substrate 142 with the heat sink 120 but the structural strength of the combination, thereby improving the heat transfer rate from the light bar 140 to the heat sink 120. As a result, a better heat dissipation effect can be obtained.

To sum up, on one hand, the light source device 100 of the invention can still have a good heat transfer effect even under the condition of using a heat sink 120 made with a low cost budge; on the other hand, a less number of high-power LEDs are allowed to be placed therein for producing sufficient luminance.

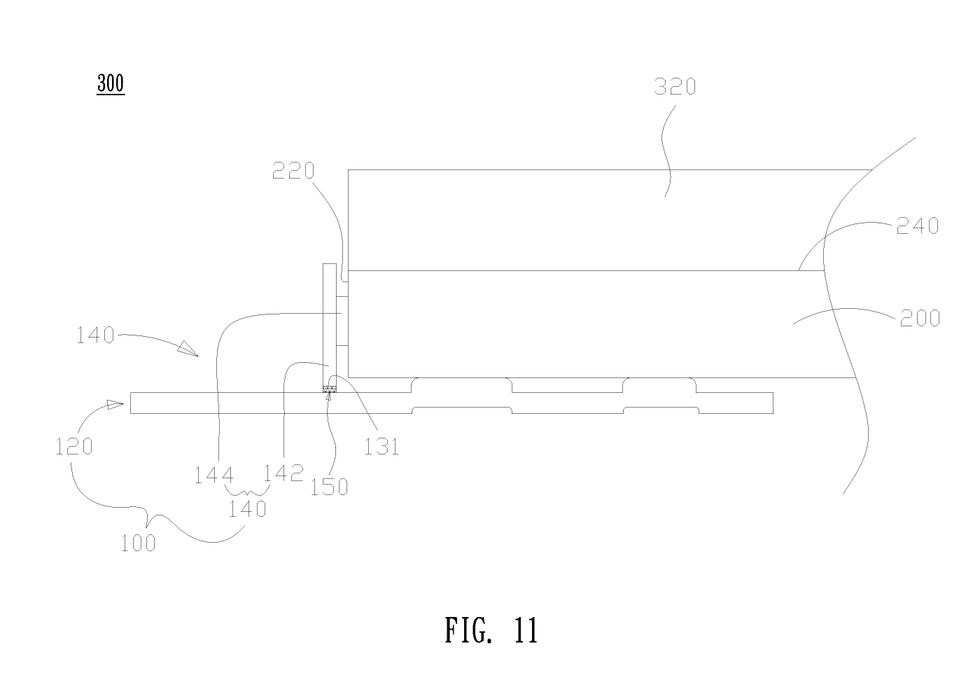

FIG. 11 illustrates the liquid crystal display 300 of the invention, comprising: a liquid crystal panel display module 320 and a backlight module 10 comprising a light guide plate 200 and a light source device 100. The light source device 100 includes a heat sink 120 and a light bar 140. The light bar 140 comprises a plurality of LEDs 144 and a substrate 142 on which the plurality of LEDs 144 are provided. The substrate 142 is bonded to an upper surface of the heat sink 120 via a side surface and forms a bonding portion between the heat sink 120. The light guide plate 200 is provided on the heat sink 120, and a light incident surface 220 of the light guide plate 200 is placed to substantially face the plurality of LEDs 144. The liquid crystal panel display module 320 is provided at the side of the light emitting surface 240 of the light guide plate 200 as shown in FIG. 11. In addition, the configuration and feature of the backlight module 10 and the light source device 100 are similar to those described in the above. The liquid crystal display 300 of the invention can furnish a better color rendering property and a longer service life because of the excellent heat dissipation effect even using high-power LEDs therein. As well, it is possible to use a narrower light bar 140 in the light source device 100 of the invention, thereby cutting the manufacturing cost and the meeting need for miniaturization.

However, the light source device described in the embodiment is not a limitation. A person of ordinary skills in the art can change arbitrarily the components except the light bar and the heat sink as required.

From the above description of the invention, it is manifest that various techniques can be used for implementing the concepts of the invention without departing from the scope thereof. Moreover, while the invention has been described with specific reference to certain embodiments, a person of ordinary skills in the art would recognize that changes can be made in form and detail without departing from the spirit and the scope of the invention. The described embodiments are to be considered in all respects as illustrative and not restrictive. It is intended that the scope of the invention is defined by the appended claims.

What is claimed is:

1. A light source device, comprising:
a heat sink; and
a light bar comprising a plurality of light emitting diodes (LEDs) and a substrate on which the LEDs are provided, the substrate being bonded to the heat sink via a bonding portion by which heat generated by LEDs is transferred to the heat sink.

2. The light source device according to claim 1, wherein the substrate is bonded to the heat sink by welding or sealing.

3. The light source device according to claim 2, wherein the heat sink is formed by extrusion molding or stamping.

4. The light source device according to claim 2, wherein the substrate is bonded to the heat sink in a substantially vertical direction, such that the LEDs on the substrate are located over the heat sink.

5. The light source device according to claim 3, wherein the heat sink further comprises a projection, and a surface of the substrate faces the projection.

6. The light source device according to claim 5, wherein the projection is formed integrally with the heat sink.

7. The light source device according to claim 5, wherein the projection is bonded by welding or sealing to a surface of the heat sink.

8. The light source device according to claim 3, wherein the heat sink further comprising a recess, and the substrate is inserted into the recess.

9. The light source device according to claim 8, wherein the recess is formed integrally with the heat sink.

10. A backlight module, comprising:
the light source device of claim 1; and
a light guide plate, a light incident surface of which faces the LEDs.

11. The backlight module according to claim 10, wherein the substrate is bonded to the heat sink by welding or sealing.

12. The backlight module according to claim 11, wherein the heat sink is formed by extrusion molding or stamping.

13. The backlight module according to claim 11, wherein the substrate is bonded to the heat sink in a substantially vertical direction such that the LEDs on the substrate are located over the heat sink.

14. The backlight module according to claim 12, wherein the heat sink further comprises a projection, and a surface of the substrate faces the projection.

15. The backlight module according to claim 14, wherein the projection is formed integrally with the heat sink.

16. The backlight module according to claim 14, wherein the projection is bonded by welding or sealing to a surface of the heat sink.

17. The backlight module according to claim 12, wherein the heat sink further comprises a recess, and the substrate is inserted into the recess.

18. The backlight module according to claim 17, wherein the recess is formed integrally with the heat sink.

19. The backlight module according to claim 12, wherein the heat sink comprises a support, the light guide plate being located above the support and the light incident surface of the light guide plate faces the LEDs.

20. A liquid crystal display, comprising:
the backlight module of claim 10; and
a liquid crystal panel display module provided at a side of a light emitting surface of the light guide plate.

21. The liquid crystal display according to claim 20, wherein the substrate is bonded to the heat sink by welding or sealing.

22. The liquid crystal display according to claim 21, wherein the heat sink is formed by extrusion molding or stamping.

23. The liquid crystal display according to claim 21, wherein the substrate is bonded to the heat sink in a substantially vertical direction such that the LEDs on the substrate are located over the heat sink.

24. The liquid crystal display according to claim 22, wherein the heat sink further comprises a projection, and a surface of the substrate faces the projection.

25. The liquid crystal display according to claim 22, wherein the heat sink further comprises a recess, and the substrate is inserted into the recess.

26. A method for manufacturing a light source device, comprising:
providing a light bar having a plurality of LEDs thereon;
providing a heat sink; and
bonding a substrate of the light bar to the heat sink such that a bonding portion is formed between the substrate and the heat sink.

27. The method according to claim 26, wherein the substrate of the light bar is bonded to the heat sink by welding or sealing.

28. The method according to claim 27, wherein the heat sink is formed by extrusion molding or stamping.

29. The method according to claim 28, further comprising:
forming a projection on a surface of the heat sink;
putting a surface of the substrate opposite to the projection of the heat sink; and
bonding the surface of the substrate to the surface of the heat sink by welding or sealing.

30. The method according to claim 28, further comprising:
forming a recess from a surface of the heat sink;
inserting the substrate into the recess of the heat sink; and
bonding the substrate to the recess of the heat sink by welding or sealing.
